(19) United States
(12) Patent Application Publication
(10) Pub. No.: US 2026/0289849 A1
(43) Pub. Date: Sep. 24, 2026

(54) METHOD AND DEVICE FOR OUTPUTTING IMAGES

(71) Applicant: NEARTHLAB INC., Seoul (KR)

(72) Inventors: Junil PARK, Seoul (KR); Junyong LEE, Seoul (KR); Youngjoo KIM, Seoul (KR)

(21) Appl. No.: 19/156,317

(22) PCT Filed: Oct. 14, 2024
(86) PCT No.: PCT/KR2024/015501

§ 371 Date: Aug. 13, 2025

(30) Foreign Application Priority Data
Jan. 18, 2024 (KR) 10-2024-0007885

(51) Int. Cl. G06T 11/60; B64C 39/02; G03B 15/00; G06T 1/20; G06T 7/00

(52) U.S. Cl. CPC G06T 11/60; B64C 39/024; G03B 15/006; G06T 1/20; G06T 7/0008; G06T 2207/30164

(57) ABSTRACT

A method for outputting an image, according to an aspect, comprises the steps of: capturing, through a camera of an aerial vehicle, at least one static image representing at least a portion of an object; generating at least one virtual image corresponding to the at least one static image; and superimposing and outputting the at least one virtual image on a dynamic image captured through the camera during flight of the aerial vehicle.

### TECHNICAL FIELD

The disclosure relates to a method and device for outputting an image.

### BACKGROUND

An aerial vehicle can fly to approach a target object, and various information about the target object can be collected through the camera of the aerial vehicle. The technology of photographing using an aerial vehicle has been practiced by being grafted onto various technical fields, and is also utilized for the inspection of industrial structures. If the target object is an industrial structure, the exterior or interior of the target object can be captured via the camera of the aerial vehicle, allowing any malfunctions, damages, or the like in the industrial structure to be identified.

If a user inspects the target object through images captured by the aerial vehicle, the aerial vehicle must capture all parts of the target object without missing any parts. However, it may be difficult to know whether the aerial vehicle has captured all parts of the target object due to the shape, size, etc., of the target object. Accordingly, there is an increasing demand for technology that can check whether there are any missing parts of the target object in the images already captured by the aerial vehicle.

### SUMMARY

### Technical Objects

It is an object of the present disclosure to provide a method and device for outputting an image. Further, it is another object of the present disclosure to provide a computer-readable recording medium having recorded thereon a program for executing the method on a computer. The objects to achieve are not limited to those described above, and other objects can exist.

### Technical Solution

A method of outputting an image according to one aspect includes the steps of capturing at least one static image showing at least a part of a target object via a camera of an aerial vehicle; generating at least one virtual image corresponding to the at least one static image; and superimposing and outputting the at least one virtual image onto a dynamic image captured via the camera during flight of the aerial vehicle.

A computer-readable recording medium according to another aspect includes a recording medium having recorded thereon a program for executing the method described above on a computer.

A device for outputting an image according to yet another aspect includes at least one memory; and at least one processor, wherein the at least one processor generates control signals to obtain at least one static image showing at least a part of a target object captured via a camera of an aerial vehicle, to generate at least one virtual image corresponding to the at least one static image, and so that the at least one virtual image is superimposed and output onto a dynamic image captured via the camera during flight of the aerial vehicle.

### BRIEF DESCRIPTION OF THE DRAWINGS

FIG. 1 is a diagram for describing one example of photographing a target object using an aerial vehicle according to one embodiment.

FIG. 2 is a diagram for describing the relationship between the aerial vehicle, and a controller, a server, and a station according to one embodiment.

FIG. 3 is a configuration diagram for describing one example of an aerial vehicle according to one embodiment.

FIG. 4 is a flowchart for describing one example of a method of outputting an image according to one embodiment.

FIG. 5 is a diagram for describing one example of a static image according to one embodiment.

FIG. 6 is a diagram for describing one example of information on the capture of a static image according to one embodiment.

FIG. 7 is a diagram for describing one example of a virtual image according to one embodiment.

FIGS. 8a to 8c are diagrams for describing examples in which the shape of a virtual image to be superimposed on a dynamic image changes according to one embodiment.

FIG. 9 is a diagram for describing one example in which the position of the aerial vehicle is output onto a dynamic image according to one embodiment.

FIG. 10 is a diagram for describing one example in which an indicator is output onto a dynamic image according to one embodiment.

FIG. 11 is a diagram for describing one example in which information indicating an area where an image capture has been missed is output according to one embodiment.

FIG. 12 is a diagram for describing one example of distinguishing between overlapping and non-overlapping areas between virtual images and outputting them.

FIG. 13 is a diagram for describing one example of distinguishing and outputting virtual images according to the time sequence in which the virtual images were captured.

FIG. 14 is a configuration diagram for describing one example of a device for outputting images according to one embodiment.

### DETAILED DESCRIPTION OF EMBODIMENTS

The terms used in the embodiments have been selected from general terms that are currently widely used as much as possible, but these may vary depending on the intention of those skilled in the art, precedents, the emergence of new technologies, and the like. In addition, in certain cases, there are terms arbitrarily selected by the applicant, and in such cases, their meanings will be described in detail in the corresponding description sections. Therefore, the terms used in the specification should be defined based on the meanings of the terms and the overall content of the specification, rather than simply the names of the terms.

Throughout the specification, when a part is said to “include” a certain component, this means that it may further include other components rather than excluding other components unless specifically stated to the contrary.

Also, terms including ordinal numbers such as “first” or “second” used in the specification may be used to describe various components, but the components should not be limited by these terms. These terms may be used for the purpose of distinguishing one component from another.

Hereinafter, embodiments will be described in detail with reference to the accompanying drawings. However, the embodiments can be implemented in a variety of different forms and are not limited to the examples described herein.

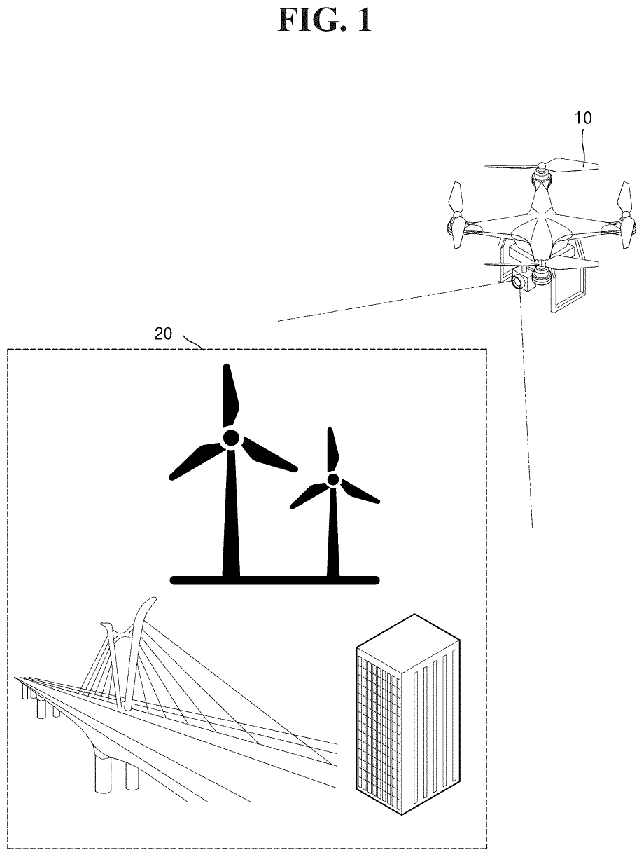

FIG. 1 is a diagram for describing one example of photographing a target object using an aerial vehicle according to one embodiment.

Any airborne body capable of flying, including a drone, an unmanned aerial vehicle (UAV), unmanned aerial mobility (UAM), an aircraft, a helicopter, etc., may fall into the aerial vehicle 10.

The aerial vehicle 10 may fly alone or together with a plurality of aerial vehicles capable of collaboration. In addition, the aerial vehicle 10 can also collaborate with other types of apparatuses, such as vehicles, robots, etc. Further, the aerial vehicle 10 may fly automatically around a target object 20 along a predetermined flight path, or may fly manually around the target object 20 according to the control of a user.

The aerial vehicle 10 may photograph the target object 20 while flying around the target object 20. For example, the images obtained by capturing the target object 20 may be used to determine whether the target object 20 has a defect (e.g., a malfunction, damage, etc.). The user may detect, recognize, and/or identify the target object 20 via the aerial vehicle 10.

As one example, the aerial vehicle 10 may photograph the body or blades of a wind turbine. Specifically, the aerial vehicle 10 may fly around the wind turbine and photograph its body or blades. For example, the aerial vehicle 10 may take off from a station at a starting point and fly to the nose of the wind turbine. Then, the aerial vehicle 10 may start photographing from the nose of the wind turbine, and may photograph the blades while flying autonomously (or flying manually) along the blades. In general, the wind turbine may include three blades, and the aerial vehicle 10 may obtain images by capturing the three blades. In this case, the images captured by the aerial vehicle 10 may be utilized for the inspection of the blades.

As another example, the aerial vehicle 10 may photograph the surface of a large building. For example, the aerial vehicle 10 may obtain images by capturing the surface while flying around the large building. In this case, the images captured by the aerial vehicle 10 may be utilized for the inspection of the surface of the large building.

FIG. 1 shows wind turbines, bridges, and large buildings as the target object 20, but the target object 20 is not limited thereto. In other words, the target object 20 may be any structure with a shape without limitations. As one example, the target object 20 may be a structure in the industrial field. The target object 20 may be, but is not limited to, a structure for generating electricity (e.g., wind turbines, thermal power plants, hydroelectric power plants, nuclear power plants, solar power generators, etc.), a large building (e.g., factories, exhibition centers, stadiums, etc.), a bridge, a dam, a power distribution line, a road, etc. As another example, the target object 20 may be a structure that needs to be detected or for which information must be collected in the security and military fields (e.g., barbed wire fences, ammunition depots, exterior walls, etc.). As yet another example, anything that is difficult or dangerous for a user to check the entirety with the naked eye and requires a lot of manpower and costs for inspection may fall within the target object 20.

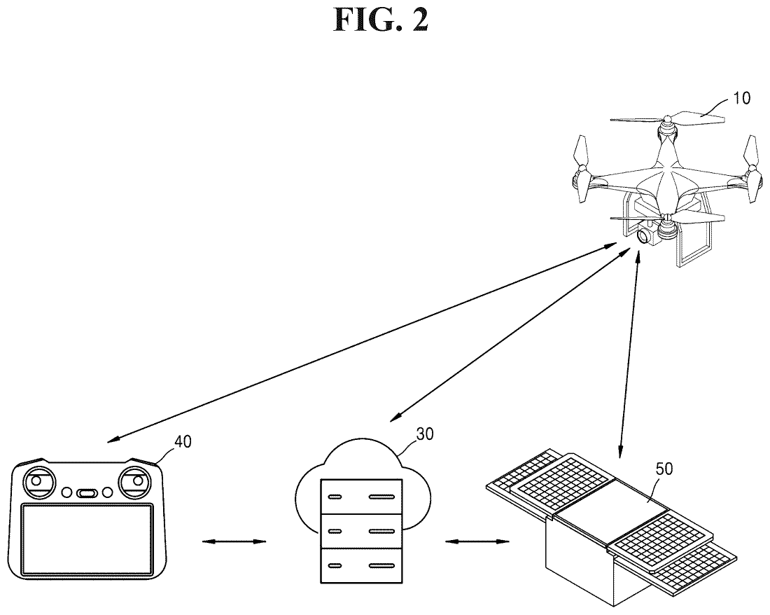

FIG. 2 is a diagram for describing the relationship between the aerial vehicle, and a controller, a server, and a station according to one embodiment.

Referring to FIG. 2, a server 30, a controller 40, and a station 50 may control the aerial vehicle 10 independently or in cooperation with one another. For example, the server 30, the controller 40, and the station 50 may control the operation (e.g., movement, rotation, etc.) of the aerial vehicle 10 or control the photographing of the aerial vehicle 10.

The aerial vehicle 10 may include at least one camera, and capture the target object 20 using the camera. For example, the camera may be provided at a position advantageous for photographing during the flight of the aerial vehicle 10 (e.g., an area not obscured by the propellers, etc., at the front or front lower part of the aerial vehicle).

For example, the aerial vehicle 10 may fly using a Global Navigation Satellite System (GNSS) and/or an Inertial Navigation System (INS).

For example, the aerial vehicle 10 may transmit and receive data to and from the server 30, the controller 40, and/or the station 50. Further, the controller 40 and the server 30, the server 30 and the station 50, and the station 50 and the controller 40 may transmit and receive data to and from each other.

Here, the data may include data necessary to control the flight of the aerial vehicle 10, data on flight images of the aerial vehicle 10, data on images obtained by capturing the target object 20 by the aerial vehicle 10, etc.

The flight images show the field of view of the aerial vehicle 10 when the aerial vehicle 10 flies. For example, the flight images may be dynamic images acquired in real time, but are not limited thereto.

The images obtained by capturing the target object 20 by the aerial vehicle 10 refer to images captured by the aerial vehicle 10 while flying around the target object 20. At this point, the images obtained by capturing the target object 20 by the aerial vehicle 10 may be used as images for checking whether the target object 20 has any defects. In this case, the images obtained by capturing the target object 20 by the aerial vehicle 10 may be referred to as inspection images.

For example, the flight images may be images with a relatively lower resolution compared to the inspection images, and the inspection images may be images with a relatively higher resolution compared to the flight images. Further, the cameras that generate the flight images and the inspection images may be the same or different depending on the type of aerial vehicle 10.

The user may control the aerial vehicle 10 by using the interface of the controller 40. For example, the controller 40 may generate a control signal according to a user input received via the interface and transmit the control signal to the aerial vehicle 10. The controller 40 may transmit the control signal to the aerial vehicle 10 in a wireless communication scheme. The control signal may be a signal that controls the flight, attitude, navigation, etc., of the aerial vehicle.

The aerial vehicle 10 may rotate the propellers by controlling the motors according to the control signal received from the controller 40. The aerial vehicle 10 may move, rotate, etc., by changing its speed and/or attitude, etc., by the rotation of the propellers. Here, the attitude of the aerial vehicle may be represented by pitch (Y), roll (X), yaw (Z), etc. In addition, the aerial vehicle may perform photographing of the target object 20, etc., according to the control signal received from the controller 40.

The controller 40 may further include a display device, and the user may check the flight images and/or the inspection images of the aerial vehicle 10 via the display device.

The controller 40 may be a device on which an application for controlling the aerial vehicle 10 is installed. For example, the device on which the application is installed may be a variety of portable devices such as a smartphone, a tablet, a smart pad, a laptop, a wearable device, etc.

The server 30 or the station 50 may control the aerial vehicle by transmitting control signals directly to the aerial vehicle 10. Further, the aerial vehicle 10 may transmit the flight images and/or the inspection images to the server 30, controller 40, or station 50.

The aerial vehicle 10, the server 30, the controller 40, and the station 50 may each analyze the inspection images. For example, the analysis of the inspection images may be checking whether there are any defects in the target object 20 in the inspection images through an algorithm such as machine learning or deep learning. The aerial vehicle 10 may directly determine whether there is a defect in the target object 20, or may transmit the inspection images to the server 30, the controller 40, or the station 50. The server 30, the controller 40, or the station 50 may determine whether there is a defect in the target object 20 by analyzing the inspection images received from the aerial vehicle 10.

On the other hand, when photographing the target object 20 by using the aerial vehicle 10, it is necessary to check whether there is any part of the target object 20 where an image capture has been missed. In particular, when determining whether there is a defect in the target object 20 by using the inspection images, inspection images of the entire target object 20 must be secured in order to accurately determine whether there is a defect in the target object 20. Accordingly, after the photographing of the target object 20 is completed, it is necessary to check which part of the target object 20 each of the images obtained by the photographing represents.

Previously, in order to check whether there was a missed image capture of the target object 20, the user either directly reviewed the images with the naked eye or reviewed the images through a solution including an image stitching function after the flight of the aerial vehicle 10 was completed.

However, additional development resources are required to provide a stitching function applicable to images obtained by capturing a variety of target objects 20, and it may be difficult for a user to immediately check whether there is a missed capture for images obtained by capturing a target object 20 in which similar patterns in their appearance are repeated.

In addition, it is necessary to check up to which part of the target object 20 the photographing has proceeded in the middle of photographing the target object 20. For example, if the photographing of the target object 20 is interrupted in the middle, it is necessary to check from which part the photographing should start again when resuming the photographing. In this case, if there are no distinctive features in the appearance of the target object 20, it may be difficult for the user to intuitively check up to which area of the target object 20 the previously captured images have captured.

Furthermore, if a missed image capture of the target object 20 is discovered after the photographing of the target object 20 is completed, it may be difficult to accurately check at which part the missed image capture has occurred, and it may be difficult to check whether all of the desired inspection images have been acquired if the target object 20 is a large structure as well.

A processor according to one embodiment may generate a control signal so as to output, onto a dynamic image, which parts of the target object 20 have already been photographed. For example, the display device may output a virtual image by superimposing it on a dynamic image corresponding to the flight image by a control signal of the processor. Here, the virtual image is generated in correspondence to an already captured static image. The virtual image may correspond one-to-one with the static image. Accordingly, the user can intuitively check the already captured parts of the target object 20 simply by checking the dynamic image. Further, through the virtual image outputted onto the dynamic image, the user can check for which parts of the target object 20 the inspection images are missing and can readily determine the position where the next inspection image should be captured.

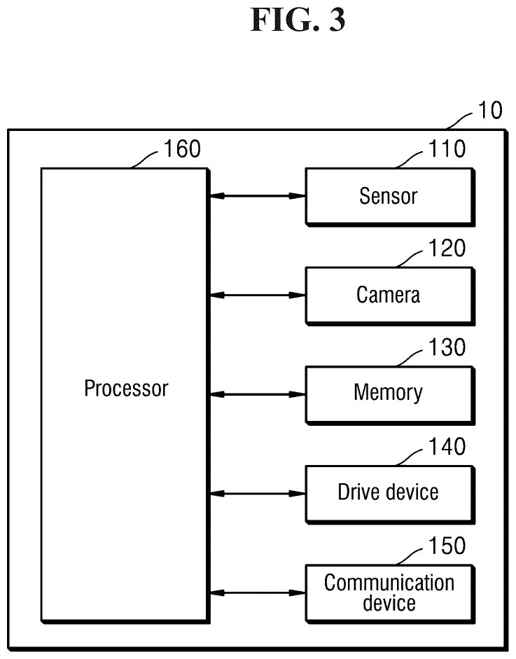

FIG. 3 is a configuration diagram for describing one example of an aerial vehicle according to one embodiment.

Referring to FIG. 3, the aerial vehicle 10 may include a sensor 110, a camera 120, a memory 130, a drive device 140, a communication device 150, and a processor 160. However, the components of the aerial vehicle 10 are not limited to those shown in FIG. 3. In other words, the aerial vehicle 10 may further include at least one component in addition to the components shown in FIG. 3, and at least one of the components shown in FIG. 3 may be excluded.

The sensor 110 senses various information necessary for the operation of the aerial vehicle 10 (e.g., flight, photographing, etc.), such as the aerial vehicle 10 itself, the surrounding environment of the aerial vehicle 10, identification of the target object 20, and checking the distance between the aerial vehicle 10 and the target object 20. The sensor 110 may include, but is not limited to, a gyro sensor, a barometer, an ultrasonic sensor, a magnetic sensor, an acceleration sensor, a proximity sensor, a lidar, a radar, and/or a GPS sensor.

For example, the gyro sensor and/or acceleration sensor can measure the three-axis angular velocity of the aerial vehicle 10. The barometer can measure pressure changes and/or air pressure in the atmosphere surrounding the aerial vehicle 10. The ultrasonic sensor can measure the distance between the aerial vehicle 10 and the ground or target object 20. The magnetic sensor is a kind of terrestrial magnetism sensor (or compass sensor) and can sense terrestrial magnetism information.

For example, the proximity sensor can measure the proximity state of the target object 20 to the aerial vehicle 10 and the distance between the aerial vehicle 10 and the target object 20, and may include an ultrasonic sensor that can output ultrasonic waves and measure the distance to the target object 20 from the signal reflected off the target object 20. The GPS sensor can calculate the current coordinates (x, y, z) of the aerial vehicle 10 by using GPS signals.

The sensor 110 may include an attitude and heading reference system (AHRS). For example, the attitude and heading reference system may include an inertial sensor or an inertial measurement unit (IMU). For example, the attitude and heading reference system may include a gyro sensor, an acceleration sensor, and a magnetic sensor, and may output the attitude values (φ, è, ø) of the aerial vehicle 10 by fusing sensor values. Here, the attitude values (φ, è, ø) may be angles based on three-dimensional coordinates (x-axis coordinate, y-axis coordinate, z-axis coordinate) according to GPS coordinates.

The camera 120 may capture the target object 20 according to the instructions of the processor 160. For example, the aerial vehicle 10 may include at least one camera, and may include a low-resolution camera and/or a high-resolution camera.

The camera 120 may be coupled with a gimbal capable of adjusting the angle. Accordingly, the camera 120 may have its photographing angle adjusted by the gimbal.

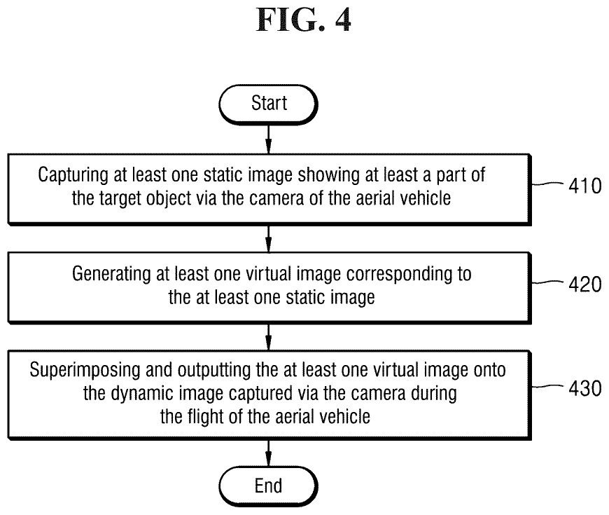

The memory 130 may include any non-transitory computer-readable recording medium. As one example, the memory 130 may include a permanent mass storage device, such as random access memory (RAM), read-only memory (ROM), a disk drive, a solid state drive (SSD), flash memory, etc. As another example, the permanent mass storage device, such as ROM, SSD, flash memory, a disk drive, etc., may be a separate persistent storage device distinct from the memory. Further, the memory 130 may store an operating system (OS) and at least one program code (e.g., code for the processor 160 to perform the operations described later with reference to FIGS. 4 to 14).

These software components may be loaded from a computer-readable recording medium separate from the memory 130. Such a separate computer-readable recording medium may be a recording medium that can be directly connected to a computer, and may include, for example, a computer-readable recording medium such as a floppy drive, a disk, a tape, a DVD/CD-ROM drive, and a memory card. Alternatively, the software components may be loaded into the memory 130 via the communication device 150 rather than a computer-readable recording medium. For example, at least one program may be loaded into the memory 160 based on a computer program (e.g., a computer program for the processor 160 to perform the operations described later with reference to FIGS. 3 to 14, etc.) installed by files provided via the communication device 150 by developers or a file distribution system that distributes installation files of an application.

The drive device 140 may control the driving of the motors at the speed and direction according to the instructions of the processor 160, and accordingly, the rotation speed and direction of the propellers connected to the motors may be controlled. For example, the drive device 140 may include the motors and the propellers.

The communication device 150 performs data communication between the aerial vehicle 10 and external devices. For example, the communication device 150 may communicate with the controller 40, the server 30, and/or the station 50 in various communication schemes, such as infrared communication, RF (radio frequency) communication, Wi-Fi communication, ZigBee communication, Bluetooth communication, laser communication, UWB (ultra-wideband) communication, LTE, 5G, 6G, and Wireless LAN. However, the communication scheme employed in the communication device 150 is not limited to what is described above.

The processor 160 may process commands of a computer program by performing basic arithmetic, logic, and input/output operations. Here, the commands may be provided from the memory 130 or an external device (e.g., the server 30, the controller 40, the station 50, etc.). Further, the processor 160 may control the operation of other components included in the aerial vehicle 10 overall.

For example, the functions performed by respective modules included in the processor 160 may be performed by a single processor or may be performed respectively by separate processors. The processor 160 may execute calculations or data processing related to the control and/or communication of at least one other component of the aerial vehicle 10.

For example, the processor 160 may obtain at least one static image showing at least a part of the target object 20 captured via the camera 120 of the aerial vehicle 10. Here, the static image refers to an image obtained by capturing the exterior and/or interior of at least a part of the target object 20.

In addition, the processor 160 may generate at least one of information on the position of the aerial vehicle 10 at a time point when the at least one static image is captured, information on the distance between the aerial vehicle 10 and the target object 20, information on the angle of view of the camera 120, and information on the direction in which the camera 120 captures the at least one static image (i.e., the photographing angle of the camera 120).

The processor 160 generates at least one virtual image corresponding to the at least one static image. Then, the processor 160 generates a control signal so that the at least one virtual image is superimposed on the dynamic image captured via the camera 120 during the flight of the aerial vehicle 10 and output to the display device. The dynamic image represents an image generated by the light measured via the camera 120. The virtual image represents an artificial image whose size, color, shape, etc., are determined by the processor 160. Since the dynamic image changes in real time by the displacement of the aerial vehicle 10, the processor 160 may generate a virtual image in real time according to the changing dynamic image. Here, the virtual image is generated by matching with the static image, and plays the role of displaying the part of the target object 20 on the static image onto the dynamic image in real time. The virtual image may be generated together when the static image is generated.

At this time, the dynamic image with the virtual image superimposed thereon may be output to at least one of a display device of the aerial vehicle 10, a display device of the server 30, a display device of the controller 40, a display device of the station 50, and a display device of another external device.

For example, the processor 160 may generate a control signal so that the shape of the at least one virtual image to be superimposed on the dynamic image changes in correspondence to at least one of a change in the target object 20 shown on the dynamic image, a change in the position of the aerial vehicle 10, and a change in the angle of view of the camera 120. Moreover, the processor 160 may generate a control signal so that a virtual image showing the position of the aerial vehicle 10 at a time point when the static image was captured is further superimposed and output onto the dynamic image.

In addition, the processor 160 may generate a control signal so that an indicator indicating the proportion of the area of the target object 20 shown in the at least one static image to the entire area of the target object 20 is output. Further, the processor 160 may generate a control signal so that information indicating areas where an image capture has been missed out of the entire area of the target object 20 is output based on the area of the target object 20 shown in the at least one static image. Moreover, the processor 160 may generate a control signal so that a static image corresponding to the virtual image is further superimposed and output onto the dynamic image. Here, the entire area of the target object 20 may represent the area planned to be photographed using the aerial vehicle 10. For example, if the target object 20 is a building and the planned area is the front of the building, the entire area of the target object 20 may be the front of the building. Further, if the target object 20 is a wind turbine and the planned area is three blades, the entire area of the target object 20 may be the surface of the three blades.

In addition, if the virtual images are plural, the processor 160 may generate a control signal so that the overlapping areas and non-overlapping areas between the virtual images are distinguished and output. Further, if the virtual images are plural, the processor 160 may generate a control signal so that the virtual images are distinguished and output according to the time sequence in which the static images were captured.

A specific description of the operations of the aerial vehicle 10 described above with reference to FIG. 3 will be given later with reference to FIGS. 4 to 13.

For example, the processor 160 may be implemented with an array of multiple logic gates, or may be implemented with a combination of a general-purpose microprocessor and a memory having stored therein a program that can be executed on the microprocessor. For example, the processor 160 may include a general-purpose processor, a central processing unit (CPU), a graphics processing unit (GPU), a microprocessor, a digital signal processor (DSP), a controller, a microcontroller, a state machine, etc. In some environments, the processor 160 may include an application-specific integrated circuit (ASIC), a programmable logic device (PLD), a field programmable gate array (FPGA), etc. For example, the processor 160 may refer to a combination of processing devices, such as a combination of a digital signal processor (DSP) and a microprocessor, a combination of a plurality of microprocessors, a combination of one or more microprocessors coupled with a digital signal processor (DSP) core, or a combination of any other such components.

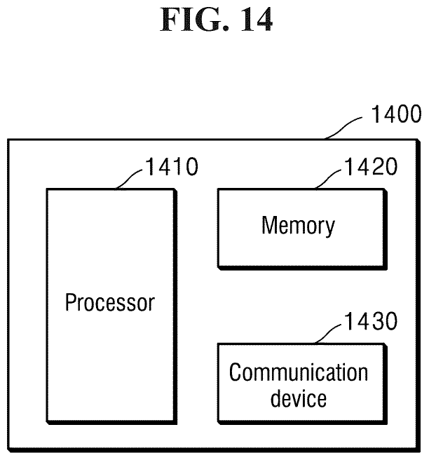

Furthermore, the operation of the processor 160 described above with reference to FIG. 3 may be implemented by a separate device. In this case, the separate device (hereinafter referred to as a “device for outputting images”) may be included in at least one of the aerial vehicle 10, the server 30, the controller 40, the station 50, and other external devices. If the device for outputting images is included in at least one of the server 30, the controller 40, the station 50, and other external devices, the aerial vehicle 10 may capture static images and dynamic images and transmit the captured images to the device for outputting images. One example of the device for outputting images will be described later with reference to FIG. 14.

FIG. 4 is a flowchart for describing one example of a method of outputting an image according to one embodiment.

The method shown in FIG. 4 consists of steps that are processed in time series by the aerial vehicle 10 or processor 160 shown in FIGS. 1 to 3. Therefore, the content described above regarding the aerial vehicle 10 or processor 160 may also be applied to the method shown in FIG. 4, even if the content is omitted below. Further, the operation of the processor 160 below may be performed by the device for outputting images shown in FIG. 14.

In step 410, the aerial vehicle 10 captures at least one static image showing at least a part of the target object via the camera 120. In other words, the processor 160 obtains at least one static image captured via the camera 120.

In addition, the processor 160 may obtain at least one of information on the position of the aerial vehicle 10 at a time point when the at least one static image is captured, information on the distance between the aerial vehicle 10 and the target object 20, information on the angle of view of the camera 120, and information on the direction in which the camera 120 captures the at least one static image (i.e., the photographing angle of the camera 120).

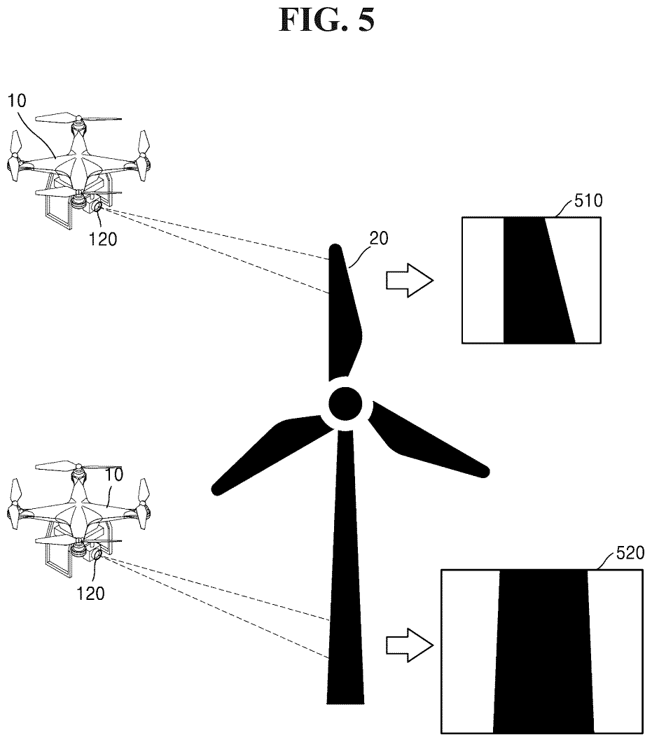

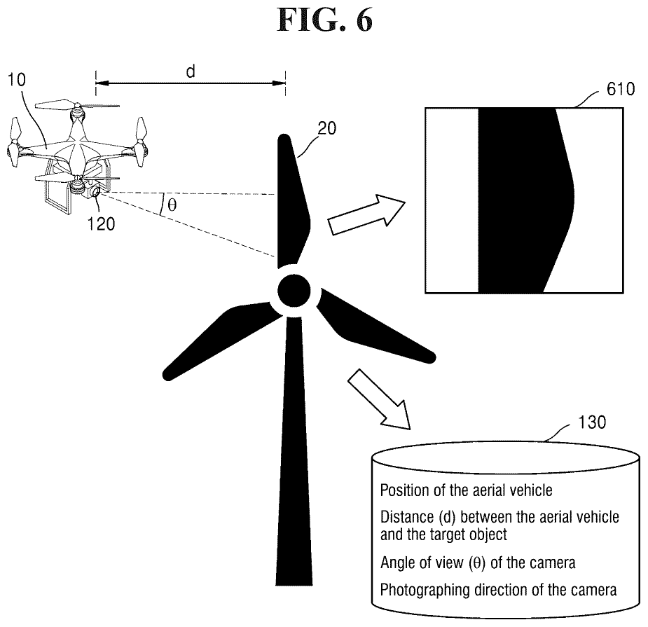

In the following, an example in which the aerial vehicle 10 captures a static image and at least one piece of information on the capture of the static image is obtained will be described with reference to FIGS. 5 and 6.

FIG. 5 is a diagram for describing one example of a static image according to one embodiment.

Referring to FIG. 5, the aerial vehicle 10 may capture the target object 20 using the camera 120 and generate static images 510 and 520. Specifically, the aerial vehicle 10 may fly around the target object 20 and generate the static images 510 and 520 according to a photographing signal of the user via the controller 40 and/or predetermined criteria (e.g., photographing at a predetermined time unit).

Depending on the size of the target object 20, the distance between the aerial vehicle 10 and the target object 20, the photographing angle of the camera 120, the angle of view of the camera 120, etc., the static images 510 and 520 may include only parts of the target object 20.

FIG. 6 is a diagram for describing one example of information on the capture of a static image according to one embodiment.

Referring to FIG. 6, when the aerial vehicle 10 has captured a static image 610, the processor 160 may generate information on the capture of the static image 610. Further, the generated information may be stored in the memory 130 together with the static image 610.

The processor 160 may generate information on the position of the aerial vehicle 10 at a time point when the static image 610 was captured. For example, the processor 160 may generate three-dimensional spatial information of the aerial vehicle 10 via the sensor 110. The processor 160 may calculate coordinates (x, y, z) for the current position of the aerial vehicle 10 by using a GPS sensor, but is not limited thereto.

In addition, the processor 160 may generate information on the distance d between the aerial vehicle 10 and the target object 20 at the time point when the static image 610 was captured. For example, the processor 160 may measure the distance d between the aerial vehicle 10 and the target object 20 by using a proximity sensor, an ultrasonic sensor, a lidar, a radar, etc., included in the sensor, but is not limited thereto.

Furthermore, the processor 160 may generate information on the angle of view θ of the camera 120 at the time point when the static image 610 was captured. Here, the angle of view θ refers to a parameter indicating the extent to which the camera 120 is capable of capturing. For example, the angle of view θ may be a value preset in the camera 120, or maybe a value adjusted by the server 30, the controller 40, and/or the station 50.

Moreover, the processor 160 may generate information on the photographing direction of the camera 120 at the time point when the static image 610 was captured. Here, the photographing direction refers to the photographing angle. For example, the processor 160 may check the tilt of the aerial vehicle 10 by measuring the three-axis angular velocity of the aerial vehicle 10 using a gyro sensor, an acceleration sensor, etc. If the camera 120 is installed on the gimbal, the processor 160 may check the tilt of the camera 120 through the tilt of the gimbal. Accordingly, the processor 160 may check the photographing direction of the camera 120 at the time point when the static image 610 was captured.

Referring again to FIG. 4, in step 420, the processor 160 generates at least one virtual image corresponding to the at least one static image. For example, the processor 160 may generate two virtual images for one static image.

The virtual image refers to an image that indicates which part of the target object 20 the static image has captured from which direction and at which angle. Therefore, the virtual image may be determined in a variety of ways as the position of the aerial vehicle 10, the distance d between the aerial vehicle 10 and the target object 20, the angle of view θ of the camera 120, the photographing direction (i.e., the photographing angle) of the camera 120, etc., vary.

For example, the virtual image may be generated in the form of a rectangular border, a semi-transparent rectangle, a rectangle filled with diagonal lines, etc., but is not limited thereto. In other words, the virtual image may be generated in various forms that can express the parts shown in the static image, or may be generated in a form that can indicate the direction, area, etc., in which the static image was captured.

In another embodiment, the processor 160 may identify the target object 20 included in the static image and generate a virtual image showing the identified part. The target object 20 included in the static image may be identified using deep learning, etc. In this case, the virtual image may be generated in a color different from that of the target object 20 and may be displayed on the surface of the target object 20 in the same shape as the identified part. For example, the processor 160 may generate a virtual image in the same shape as the part of the target object 20 displayed in black in the static image 610 in FIG. 6, or may generate a virtual image with only the border of the part of the target object 20 displayed in black.

The processor 160 may determine the position of the virtual image when the static image is generated. When it is assumed that the camera 120 has captured an arbitrary plane in a three-dimensional space and a static image of the plane has been generated, the processor 160 may determine the position of the plane included in the static image as the position of the virtual image. For example, when the static image is rectangular, the processor 160 may determine the GPS coordinates of the four vertices of the rectangle as the position of the virtual image.

As one example, the arbitrary plane may be a plane parallel to the target object 20. The processor 160 may determine the position of the virtual image with the coordinates on the plane parallel to the target object 20 included in the static image. The processor 160 may compute the plane parallel to the target object 20 by using information on the target object 20.

As another example, the arbitrary plane may be a plane perpendicular to the photographing angle. The processor 160 may determine the position of the virtual image with the coordinates on the plane perpendicular to the photographing angle. The processor 160 may compute the photographing angle of the static image through the tilt of the aerial vehicle 10 and the photographing direction of the camera 120. The plane perpendicular to the photographing angle of the static image may be a plane located between the aerial vehicle 10 and the target object 20 or on the surface of the target object 20. The processor 160 may determine the position of the virtual image by using the photographing angle of the static image and the distance d between the aerial vehicle 10 and the target object 20. For example, the arbitrary plane may be a plane perpendicular to the photographing angle of the static image at a position with a distance d away.

The processor 160 may determine the plane, and determine the size of the virtual image through the angle of view of the camera 120 and the distance d. The wider the angle of view of the camera 120 and the longer the distance d, the larger the size of the virtual image may be.

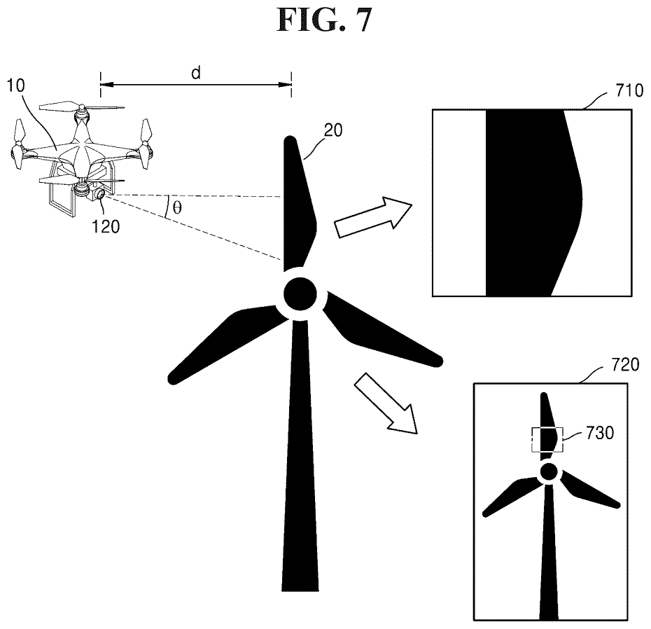

In the following, an example of generating a virtual image will be described with reference to FIG. 7.

FIG. 7 is a diagram for describing one example of a virtual image according to one embodiment.

Referring to FIG. 7, when a static image 710 is generated as the camera 120 captures the target object 20, the processor 160 generates a virtual image 730 corresponding to the static image 710.

For example, the processor 160 may check the position of the aerial vehicle 10, the distance d between the aerial vehicle 10 and the target object 20, the angle of view θ of the camera 120, and the photographing direction (i.e., photographing angle) of the camera 120 at the time point of photographing. And, the processor 160 may check the position of the static image 710. For example, the processor 160 may check the position of the static image 710 by using GPS coordinates corresponding to the center point or vertices of the static image 710.

Accordingly, the processor 160 may detect the part corresponding to the static image 710 in the target object 20 (i.e., the part of the target object 20 shown in the static image 710), and generate a virtual image 730 including the detected part.

Since the virtual image 730 is generated in correspondence to the static image 710, the size, shape, etc., of the virtual image 730 may be adaptively changed according to the position, direction, size, etc., of the target object 20 shown in a flight image (i.e., dynamic image) 720 of the aerial vehicle 10.

Referring again to FIG. 4, in step 430, the processor 160 superimposes and outputs the at least one virtual image onto the dynamic image captured via the camera 120 during the flight of the aerial vehicle 10.

For example, the dynamic image may be a flight image generated according to the current flight of the aerial vehicle 10, or may be a flight image previously generated according to the past flight of the aerial vehicle 10.

The GPS coordinates corresponding to the current position of the aerial vehicle 10 change as the aerial vehicle 10 flies, and accordingly, the difference between the GPS coordinates of the static image and the GPS coordinates corresponding to the current position of the aerial vehicle 10 may change in real time. Therefore, the processor 160 may adaptively change the size, shape, etc., of the virtual image superimposed on the dynamic image according to the flight of the aerial vehicle 10 by using the difference between the GPS coordinates of the aerial vehicle 10 and the GPS coordinates of the static image.

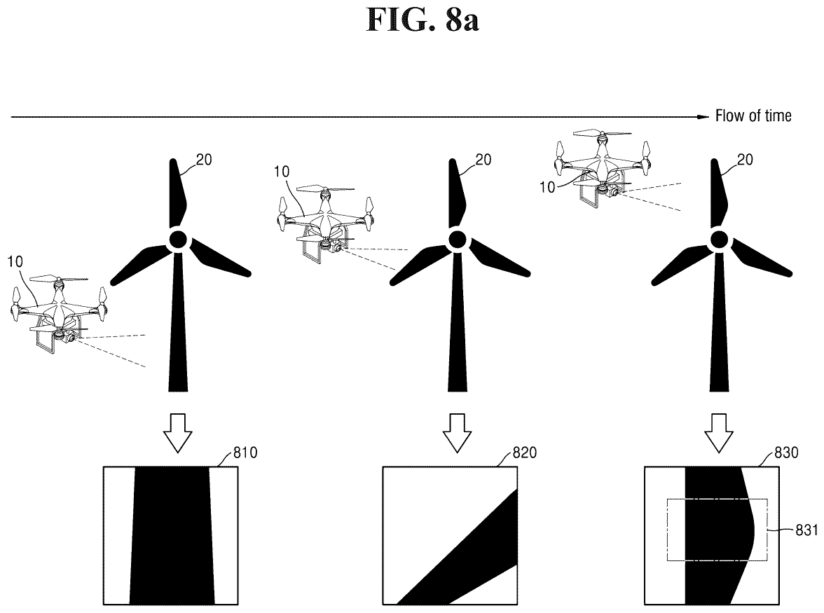

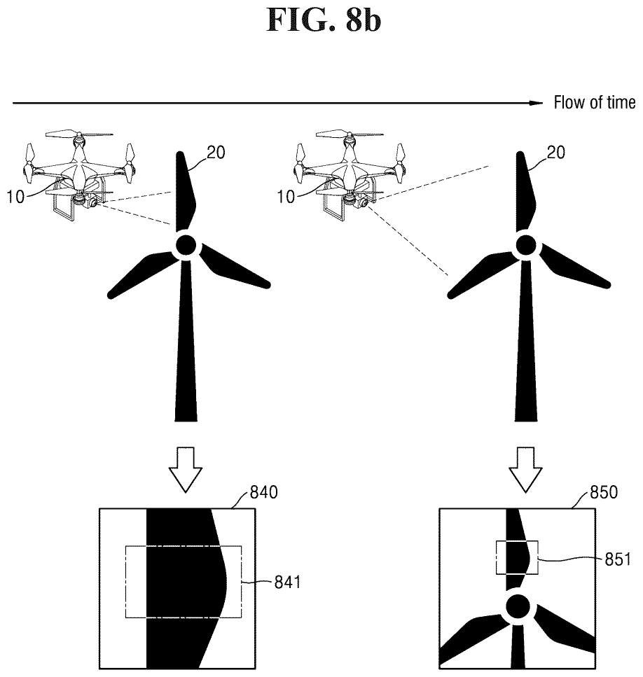

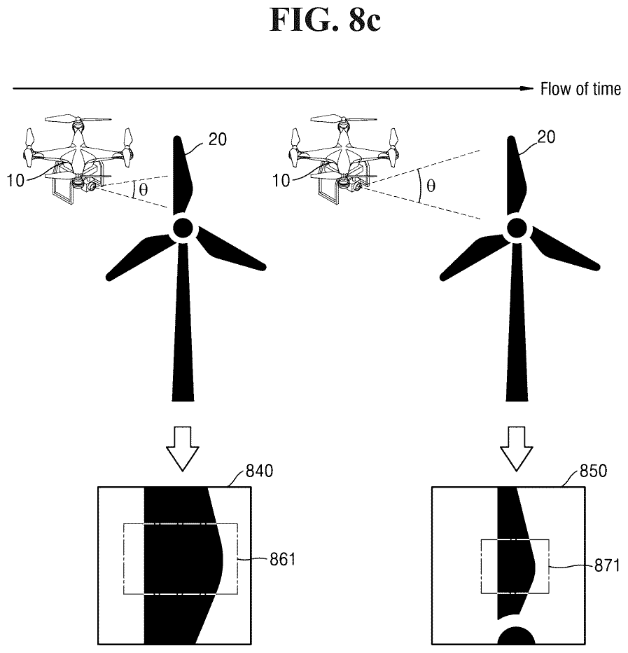

In the following, examples in which the processor 160 superimposes and outputs a virtual image onto a dynamic image will be described with reference to FIGS. 8a to 13.

FIGS. 8a to 8c are diagrams for describing examples in which the shape of a virtual image to be superimposed on a dynamic image changes according to one embodiment.

Referring to FIGS. 8a to 8c, the processor 160 generates a control signal so that the shape of the virtual image to be superimposed on the dynamic image changes in correspondence to at least one of a change in the target object shown on the dynamic image, a change in the position of the aerial vehicle 10, and a change in the angle of view of the camera 120. According to the control signal of the processor 160, the shape of the virtual image in the dynamic image outputted to the display device changes in real time.

Furthermore, a description will be made assuming that a previously captured static image in FIGS. 8a to 8c is the static image 710 shown in FIG. 7.

FIG. 8a shows an example in which the target object 20 shown on the dynamic image changes. For example, it is assumed that the aerial vehicle 10 flies in the direction from the lower part to the upper part of the target object 20. Accordingly, the target object 20 is output in the direction from the lower part to the upper part on the dynamic image as well. Since the aerial vehicle 10 has captured the static image of a part of the upper part of the target object 20, a virtual image 831 may be superimposed and output onto the dynamic image when the upper part of the target object 20 appears in the dynamic image.

For convenience of description, FIG. 8a shows a still cut 810 showing the lower part, a still cut 820 showing the middle part, and a still cut 830 showing the upper part of the dynamic image. Therefore, the virtual image 831 may only be represented on the still cut 830 showing the upper part, as described above.

FIG. 8b shows an example in which the position of the aerial vehicle 10 that captures the dynamic image changes. For example, it is assumed that the aerial vehicle 10 flies in a direction that gradually moves away from the target object 20. Accordingly, more areas of the target object 20 are gradually output on the dynamic image. Therefore, the size of the virtual images 841 and 851 superimposed on the dynamic images is also output to decrease gradually.

For convenience of description, FIG. 8b shows a still cut 840 at a time point when closer to the target object 20 and a still cut 850 at a time point when far from the target object 20, of the dynamic image. Therefore, the size of the virtual image 841 may be represented to be larger than the size of the virtual image 851, as described above.

FIG. 8c shows an example in which the angle of view of the camera 120 changes. For example, it is assumed that the angle of view of the camera 120 gradually increases while the position of the aerial vehicle 10 remains fixed. Accordingly, more areas of the target object 20 are gradually output on the dynamic image. Therefore, the size of the virtual images 861 and 871 superimposed on the dynamic images is output to decrease gradually.

For convenience of description, FIG. 8c shows a still cut 850 at a time point when the angle of view has widened and a still cut 840 at a time point when the angle of view has narrowed, of the dynamic image. Therefore, the size of the virtual image 861 may be represented to be larger than the size of the virtual image 871, as described above.

On the other hand, although not shown in FIGS. 8a to 8c, the aerial vehicle 10 may fly while revolving 360° around the target object 20. Further, the examples shown in FIGS. 8a to 8c may occur successively. In this case as well, the virtual image may be output onto the dynamic image or its size or shape may change in real time in response to the changes in the target object shown on the dynamic image.

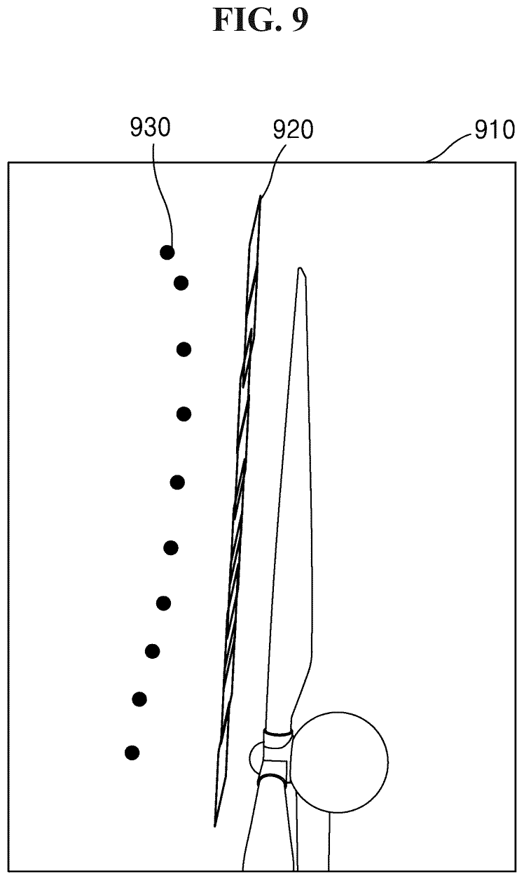

FIG. 9 is a diagram for describing one example in which the position of the aerial vehicle is output onto a dynamic image according to one embodiment.

Referring to FIG. 9, the processor 160 generates a control signal so that a virtual image 930 showing the position of the aerial vehicle 10 at the time point when the static image was captured is further superimposed and output onto the dynamic image. The virtual image 930 showing the position of the aerial vehicle 10 is displayed with a dot in FIG. 9, but the virtual image 930 may be displayed with a rectangle, an arrow, or the like. If the virtual image 930 is displayed with an arrow, the direction of the arrow may indicate the movement direction of the aerial vehicle 10 or the photographing direction. According to the control signal of the processor 160, the position of the aerial vehicle 10 at the time point when the static image was captured can be checked in the dynamic image outputted to the display device.

For example, the processor 160 may generate the virtual image 930 showing the position of the aerial vehicle 10 so as to be different from a virtual image 920 corresponding to the static image. Further, the virtual image 920 and the virtual image 930 may be output together onto the dynamic image. Accordingly, the user can simultaneously check the part where the static image was captured and the position of the aerial vehicle 10 at the time point when the static image was captured by observing the dynamic image.

For convenience of description, FIG. 9 shows a still cut 910 of the dynamic image. Therefore, the number of virtual images 920 and the number of virtual images 930 can be represented identically in the still cut 910.

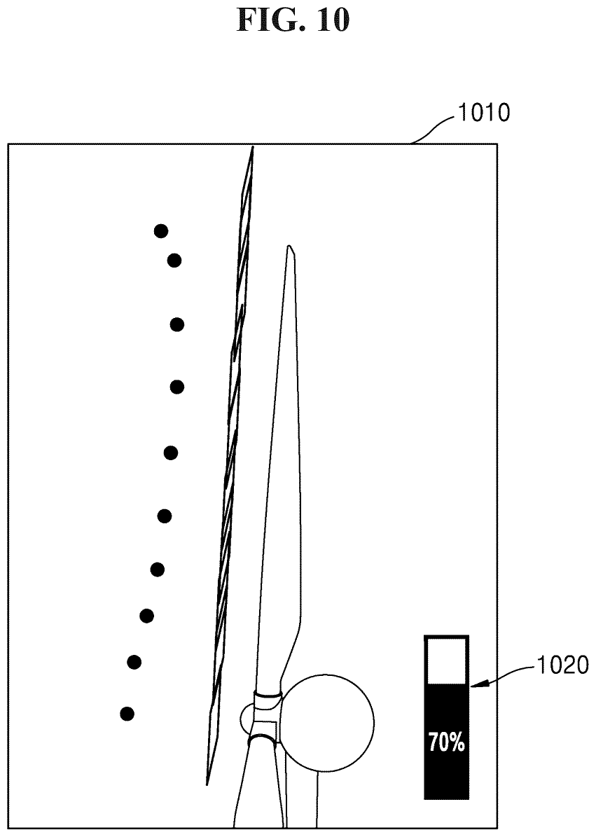

The virtual image 920 is displayed at a distance from the target object 20 in FIGS. 9 and 10, but the virtual image 920 may be displayed on the surface of the target object 20. The still cut 910 of the dynamic image is an image captured from the side of the wind turbine, and the virtual image 920 has been generated in correspondence to the static image captured from the front of the wind turbine. Therefore, the virtual image 920 in FIG. 9 is represented as if viewing a rectangle from the side.

FIG. 10 is a diagram for describing one example in which an indicator is output onto a dynamic image according to one embodiment.

Referring to FIG. 10, the processor 160 generates a control signal so that an indicator 1020, which represents the proportion of the area of the target object 20 shown (or included) in the at least one static image to the entire area of the target object 20, is output. According to the control signal of the processor 160, information on the area of the target object 20 captured as the static image can be checked in the dynamic image outputted to the display device.

The indicator 1020 indicates the extent to which the target object 20 has been photographed in FIG. 10, but the indicator 1020 may also indicate a flight time, a mission completion percentage, etc.

For convenience of description, FIG. 10 shows a still cut 1010 of the dynamic image. Therefore, the proportion in the indicator 1020 can be changed in real time in the dynamic image.

The processor 160 may check the part corresponding to the target object 20 in the previously captured static image. Further, overlapping parts of the target object 20 may also be checked among a plurality of static images. For example, the processor 160 may check the part corresponding to the target object 20 and the overlapping parts in the previously captured static images through the information on the position of the aerial vehicle 10 at the time point when the static image was captured, the information on the distance between the aerial vehicle 10 and the target object 20, the information on the angle of view of the camera 120, and the information on the direction in which the camera 120 captures the at least one static image (i.e., the photographing angle of the camera 120). Therefore, the processor 160 can calculate the proportion of the area captured as the static image to the entire area of the target object 20, and generate a control signal so that the calculated proportion is output to the indicator 1020.

Furthermore, FIG. 10 shows a bar as an example of the indicator 1020, but the indicator 1020 is not limited thereto. In other words, any form that allows for knowing the proportion of the area captured as the static image to the entire area of the target object 20 may fall within the indicator without limitations.

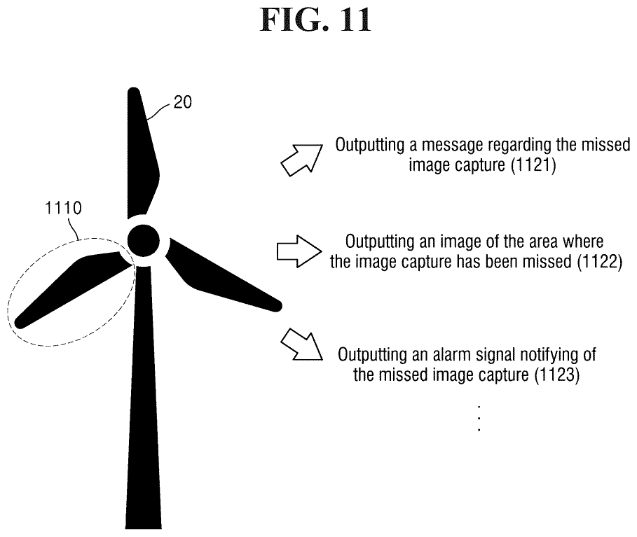

FIG. 11 is a diagram for describing one example in which information indicating an area where an image capture has been missed is output according to one embodiment.

Referring to FIG. 11, the processor 160 generates a control signal so that information indicating an area 1110 where an image capture has been missed out of the entire area of the target object 20 is output, based on the area of the target object 20 shown in the at least one static image. According to the control signal of the processor 160, the user can intuitively check whether there is any missed image capture.

FIG. 11 shows an example in which a part 1110 of the target object 20 is missing in a static image captured by a camera 120. The processor 160 may check whether there is a part 1110 where the image capture has been missed by analyzing the area of the target object 20 in the previously captured static image.

As one example, if there exists a part 1110 where the image capture has been missed, the processor 160 may output a message regarding the missed image capture (1121). For example, a sound that notifies of the missed image capture may be output.

As another example, if there exists a part 1110 where the image capture has been missed, the processor 160 may output an image of the area where the image capture has been missed (1122). For example, an image, in which only the part where the image capture has been missed is highlighted or only the part where the image capture has been missed is shown separately in the target object 20, may be output.

As yet another example, if there exists a part 1110 where the image capture has been missed, the processor 160 may output an alarm signal that notifies of the missed image capture (1123). For example, the alarm signal may be a preset melody or a vibration signal.

Moreover, the processor 160 may generate various signals or information that can notify the user of a missed image capture, in addition to the examples described above with reference to FIG. 11.

Furthermore, although not shown in FIGS. 7 to 11, the processor 160 may generate a control signal so that a static image corresponding to the virtual image is further superimposed and output on the dynamic image. For example, referring to FIG. 7, the static image 710 corresponding to the virtual image 730 may be superimposed and output inside the virtual image 730. In general, the virtual image 730 is displayed with a rectangular border on the dynamic image, but the static image 710 may be output together inside the virtual image 730.

As yet another example, only the static image 710 may be output instead of the virtual image 730, or only the target object 20 included in the static image 710 may be output.

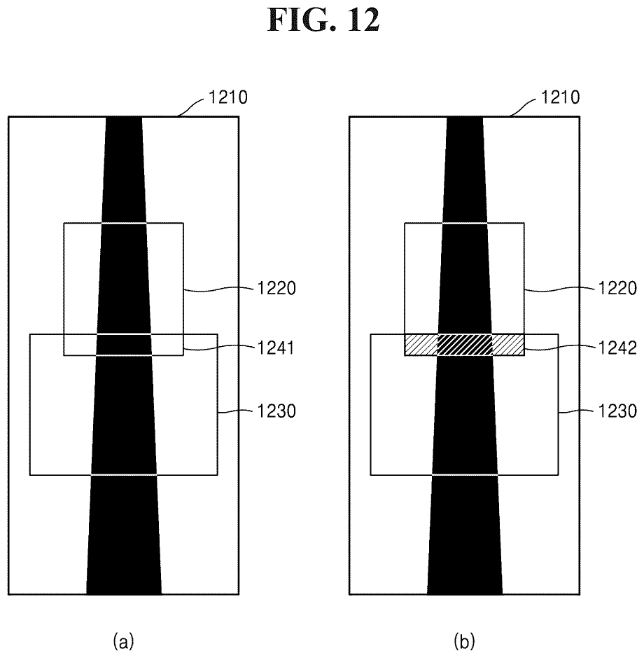

FIG. 12 is a diagram for describing one example of distinguishing between overlapping and non-overlapping areas between virtual images and outputting them.

Referring to FIG. 12, if the virtual images are plural, the processor 160 may generate a control signal so that overlapping and non-overlapping areas between the virtual images are distinguished and output. Accordingly, the parts where the target object 20 is captured in an overlapping manner among the static images may be checked in the dynamic image outputted to the display device.

For convenience of description, FIG. 12 shows a still cut 1210 of the dynamic image. For example, it is assumed that a first static image and a second static image have been captured and that there is an overlapping area between them. At this time, a first virtual image 1220 matched to the first static image and a second virtual image 1230 matched to the second static image may be output onto the still cut 1210.

And, overlapping areas 1241 and 1242 may be included between the virtual images 1220 and 1230. At this time, the processor 160 may mark the overlapping area 1242 with hatching, color, etc., to distinguish it from the non-overlapping area.

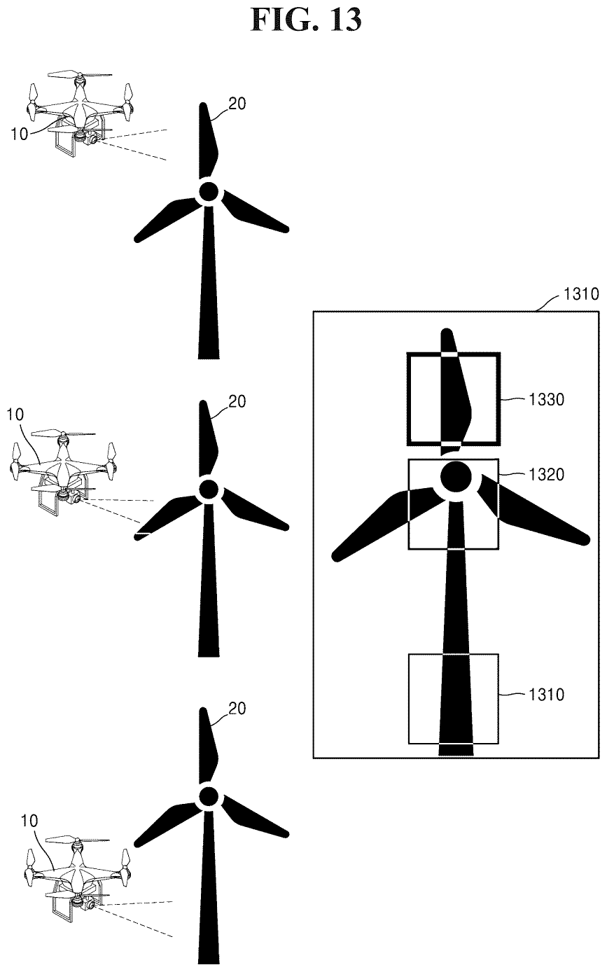

FIG. 13 is a diagram for describing one example of distinguishing and outputting virtual images according to the time sequence in which the virtual images were captured.

Referring to FIG. 13, if the virtual images are plural, the processor 160 may generate a control signal so that the virtual images are distinguished and output according to the time sequence in which the static images were captured. Accordingly, the sequence in which the static images were captured can be checked in the dynamic image outputted to the display device.

For convenience of description, FIG. 13 shows a still cut 1310 of the dynamic image. For example, it is assumed that a total of three static images have been captured while the aerial vehicle 10 flies in the direction from the lower part to the upper part of the target object 20. At this time, virtual images 1310, 1320, and 1330 matched to each of the static images may be output so as to be distinguished from one another onto the still cut 1310. The thickness of the virtual image 1330 is output to be thicker than that of the virtual image 1320, and the thickness of the virtual image 1320 is output to be thicker than that of the virtual image 1310.

FIG. 13 shows an example in which a virtual image matching a static image that was captured later is marked with a thicker outline. However, without being limited to the example shown in FIG. 13, any form that allows the capture sequence of the static images to be checked can be applied with no restrictions.

FIG. 14 is a configuration diagram for describing one example of a device for outputting images according to one embodiment.

Referring to FIG. 14, the device 1400 for outputting images includes a processor 1410, a memory 1420, and a communication device 1430. However, the components of the device 1400 are not limited to those shown in FIG. 14. In other words, the device 1400 may further include at least one component in addition to the components shown in FIG. 14, and at least one of the components shown in FIG. 14 may be excluded.

As described above with reference to FIG. 3, the device 1400 may be included in at least one of the aerial vehicle 10, the server 30, the controller 40, the station 50, and other external devices. Therefore, the processor 160, the memory 130, and the communication device 150 described above with reference to FIG. 3 may correspond to the processor 1410, the memory 1420, and the communication device 1430 of the device 1400, respectively. Thus, a detailed description of the processor 1410, the memory 1420, and the communication device 1430 will be omitted.

According to the foregoing description, the processors 160 and 1410 may generate a control signal so as to output, onto a dynamic image, which parts of the target object 20 have already been captured. For example, the display device may output a virtual image by superimposing it on a dynamic image corresponding to a flight image by a control signal of the processors 160 and 1410. Here, the virtual image is generated in correspondence to an already captured static image. Accordingly, the user can intuitively check the already captured parts of the target object 20 simply by checking the dynamic image. Further, through the virtual image outputted onto the dynamic image, the user can check for which parts of the target object 20 the inspection images are missing and can readily determine the position where the next inspection image should be captured.

Furthermore, the method described above can be written as a computer-executable program, and may be implemented on a general-purpose digital computer that runs the program using a computer-readable recording medium. In addition, the structure of the data used in the method described above may be recorded on a computer-readable recording medium through various means. The computer-readable recording medium includes a storage medium such as a magnetic storage medium (e.g., ROM, RAM, USB, floppy disks, hard disks, etc.) and an optically readable medium (e.g., CD-ROM, DVD, etc.).

Those skilled in the art related to the present embodiment will understand that it can be implemented in modified forms without departing from the essential characteristics of the above description. Therefore, the disclosed methods should be considered from an illustrative perspective rather than a restrictive perspective, and the scope of rights is indicated in the claims rather than the foregoing description, and should be interpreted as including all differences within the equivalent scope thereof.

### DESCRIPTION OF REFERENCE NUMERALS

10: Aerial vehicle
20: Target object

What is claimed:

1. A method of outputting an image, comprising the steps of:
capturing at least one static image showing at least a part of a target object via a camera of an aerial vehicle;
generating at least one virtual image corresponding to the at least one static image; and
superimposing and outputting the at least one virtual image onto a dynamic image captured via the camera during flight of the aerial vehicle.

2. The method of claim 1, further comprising the step of:
generating at least one of information on a position of the aerial vehicle at a time point when the at least one static image is captured, information on a distance between the aerial vehicle and the target object, information on an angle of view of the camera, and information on a direction in which the camera captures the at least one static image.

3. The method of claim 1, wherein, in the step of outputting, a shape of the at least one virtual image superimposed on the dynamic image changes in correspondence to at least one of a change in the target object shown on the dynamic image, a change in a position of the aerial vehicle, and a change in an angle of view of the camera.

4. The method of claim 1, wherein the step of outputting further superimposes and outputs a virtual image, which shows a position of the aerial vehicle at a time point when the static image was captured, onto the dynamic image.

5. The method of claim 1, further comprising the step of:
outputting an indicator indicating a proportion of an area of the target object shown in the at least one static image to an entire area of the target object.

6. The method of claim 1, further comprising the step of:
outputting information indicating areas where an image capture has been missed out of an entire area of the target object, based on an area of the target object shown in the at least one static image.

7. The method of claim 1, wherein the step of outputting further superimposes and outputs the static image corresponding to the virtual image onto the dynamic image.

8. The method of claim 1, wherein if the virtual images are plural, the step of outputting distinguishes between overlapping areas and non-overlapping areas between the virtual images and outputs the areas.

9. The method of claim 1, wherein if the virtual images are plural, the step of outputting distinguishes and outputs the virtual images according to a time sequence in which the static images were captured.

10. A computer-readable recording medium having recorded thereon a program for executing the method of claim 1 on a computer.

11. A device for outputting an image, comprising:
at least one memory; and
at least one processor,
wherein the at least one processor generates control signals to obtain at least one static image showing at least a part of a target object captured via a camera of an aerial vehicle, to generate at least one virtual image corresponding to the at least one static image, and so that the at least one virtual image is superimposed and output onto a dynamic image captured via the camera during flight of the aerial vehicle.

12. The device of claim 11, wherein the at least one processor generates at least one of information on a position of the aerial vehicle at a time point when the at least one static image is captured, information on a distance between the aerial vehicle and the target object, information on an angle of view of the camera, and information on a direction in which the camera captures the at least one static image.

13. The device of claim 11, wherein the at least one processor generates a control signal so that a shape of the at least one virtual image superimposed on the dynamic image changes in correspondence to at least one of a change in the target object shown on the dynamic image, a change in a position of the aerial vehicle, and a change in an angle of view of the camera.

14. The device of claim 11, wherein the at least one processor generates a control signal so that a virtual image showing a position of the aerial vehicle at a time point when the static image was captured is further superimposed and output onto the dynamic image.

15. The device of claim 11, wherein the at least one processor generates a control signal so that an indicator indicating a proportion of an area of the target object shown in the at least one static image to an entire area of the target object is output.

16. The device of claim 11, wherein the at least one processor generates a control signal so that information indicating areas where an image capture has been missed out of an entire area of the target object is output, based on an area of the target object shown in the at least one static image.

17. The device of claim 11, wherein the at least one processor generates a control signal so that the static image corresponding to the virtual image is further superimposed and output onto the dynamic image.

18. The device of claim 11, wherein if the virtual images are plural, the at least one processor generates a control signal so that overlapping areas and non-overlapping areas between the virtual images are distinguished and output.

19. The device of claim 11, wherein if the virtual images are plural, the at least one processor generates a control signal so that the virtual images are distinguished and output according to a time sequence in which the static images were captured.

20. An aerial vehicle for outputting an image, comprising:
at least one camera;
at least one memory; and
at least one processor,
wherein the at least one processor generates control signals to obtain at least one static image showing at least a part of a target object captured via the camera, to generate at least one virtual image corresponding to the at least one static image, and so that the at least one virtual image is superimposed and output onto a dynamic image captured via the camera during flight of the aerial vehicle.
